(19) United States
(12) Patent Application Publication
(10) Pub. No.: US 2011/0295740 A1
(43) Pub. Date: Dec. 1, 2011

(54) System And Method For Secure Transactions

(76) Inventor: Dane Blackwell, Calgary (CA)

(21) Appl. No.: 12/790,009

(22) Filed: May 28, 2010

(51) Int. Cl. G06Q 40/00

(52) U.S. Cl. 705/39

(57) ABSTRACT

A secure transaction system includes an image generator configured to generate human readable characters, a random placement generator coupled to the image generator, and an encoding system configured to encode the human readable characters in a data stream in an order determined by the placement generator, wherein the transaction system is configured to transmit the data stream to a user interface and to receive a selected data stream from the user interface. Also included is a method for secure transaction processing including receiving an encoded data stream representative of a plurality of human readable characters positioned in a random order, selecting a human readable character from the plurality of human readable characters, and transmitting a portion of an encoded data stream representative of the selected human readable character.

### TECHNICAL FIELD

This application is directed generally to a secure data input system and more particularly to an encoded visual authentication system and method for secure transactions.

### BACKGROUND

The financial services industry has been challenged to protect electronic financial transactions or other types of sensitive information, such as Social Security numbers, credit card numbers, pin codes or other types of authentication or validation information that a user may need to provide to validate their identity, process a financial transaction or otherwise invoke a transaction electronically. The proliferation of online banking, internet purchases or other types of transactions that are authenticated by having the user provide such sensitive information electronically has also caused a proliferation of schemes used by thieves to steal this information for the purpose of perpetrating banking, credit card and other types of financial fraud. Various methods have been used to try to keep information private and secure during these electronic transactions, such as, but not limited to:
Secure sockets;
Security PINs on the face or back of the card; and
Matching up home phone number and billing information to the credit card data entered.

The problem with these methods is that they do not, and cannot, protect from local key logging programs or other methods that may capture and record the users' character input through some type of character input interface, such as but not limited to computer keyboards, key entry pads, touch screens or other such human/machine interfaces. All these devices provide a method for a user to recognize and then input some combination of characters needed to complete a transaction, and convert these inputs into Machine Recognizable Characters, hereinafter referred to as MRC. Any scheme capable of intercepting MRC, such as key-logging software, or physical input interception, such as tapping into the keypad input of an Automated Teller Machine (ATM) or a security keypad for building entry provide an opportunity for the inputted information to be intercepted, recorded and possibly used for other purposes, many of them fraudulent. For the purposes of this disclosure, where the human input interface and the MRC interface are essentially one and the same could be called Character Logging Systems (‘CLS’).

When a user engages in some type of financial or other type of transaction, hereinafter referred to as a transaction, they enter some amount of information, which could be as little as a four digit pin for an ATM transaction or could be required to fill in an electronic form requiring more information, such as their name, address or other types of information that uniquely identify them to and for the purposes of validating the transaction, hereinafter referred to as transaction validation information (Transaction Validation Information). For security purposes transaction validation information forms some portion of the total information for the transaction. The invention provides a system and method for a user to input transaction validation information for the purposes of a transaction that obviates the ability of unauthorized capture or recording of MRC that could then be used for purposes other than intended by the person entering the transaction validation information.

Even though transaction security is of great importance to both parties in the transaction, user convenience which has driven the proliferation of electronic transaction continues to be an important aspect of these transactions. Great efforts are made to simplify and or streamline the transaction process, especially in transactions of a repetitive nature, such as but not limited to the use of a Credit Card or Bank Card, hereinafter referred severally or collectively as CC transactions, or possibly for the purchase of goods or services over the internet. For this reason, some information may be retained in a database of some type, whether locally or remotely to minimize the amount of repetitive input a user may need to manually input to complete the transaction, such as a user's name, address, user ID or possibly some portion of their CC numbers. Alternatively, some systems use barcode or magnetic strip or RF tag readers to capture some portion of the transaction information to provide more user convenience, or to eliminate the need for a user to memorize such input. The remaining digits or characters of the transaction validation information, whether other CC data, or a pin or security code only known to the user are not entered automatically, so that the act of a user inputting the transaction validation information can be used to finalize and validate the transaction. Each time this occurs, the system managing the transaction typically also assigns a unique Session ID, to uniquely identify that particular transaction, hereinafter referred to as the Transaction Session (TS). Theoretically, the uniqueness of all the information contained in the transaction, along with the TS ID and the transaction validation information, collectively produce a secure transaction.

One strategy employed to hinder software or programs that collect electronic information and then use this information for purposes other than originally intended by the system which uniquely generated this information is to introduce images that contain a sequence of randomly generated characters which can be recognized only by a human.

The theory used is that if at least some portion of the transaction session is generated and inputted by a person or “human”, because this character sequence is made up of only Human Recognizable Characters (HRC), then a software program or other system that understands and can reproduce machine readable code could not be used to spoof or otherwise compromise the transaction session. These types of images are commonly referred to as “CAPTCHA” images, which generate random character sequences for each transaction session. However, it is of little use to introduce unique information that could be considered secure, if a CLS is running during the transaction session capturing session input from the user, as the process of human readable character to MRC conversion has already occurred, obviating this methodology's usefulness for transactions that must be highly secure. Essentially, even though the information in the image means nothing to such software, when the user inputs; 8d6687, the CLS now possesses the information. So, from the standpoint of security, the most secure solution would validate that input received by the TS system was “Human Input”, and that the correct transaction validation information had been entered, and this therefore could only have come from the user who was in possession of this information.

At a first level, what is therefore missing in current art is a method that can produce highly secure transaction validation information using human readable characters that cannot be converted locally to MRC by a CLS or other such methods, which is also specific to a single TS, and at a second level remains secure independent of the volume of TS transaction validation information other systems may be able to intercept or record, which collectively could be used to decrypt or decode the transaction validation information, such as systems which record the flow of electronic information over the internet, and then use decryption software that compares large amounts of data to break such decryption.

### SUMMARY

A server generated array of images representing specific secret digits or characters to be presented on a remote terminal allowing a user to visually or audibly determine which representations match some local private alphanumeric information then pass those choices back to the server securely.

The disclosure is directed to a secure transaction system includes an image generator configured to generate human readable characters, a random placement generator coupled to the image generator, an encoding system configured to encode the human readable characters in a data stream in an order determined by the placement generator, wherein the transaction system is configured to transmit the data stream to a user interface and to receive a selected data stream from the user interface. The transaction system is configured to further receive machine readable codes in addition to the selected data stream. The disclosure further includes a card processor interface configured to communicate with a credit card processor wherein the secure transaction server decodes the selected data stream to a machine readable character and transmits the machine readable character to the card processor. The selected data stream may represent a character selected at the user interface and the machine readable character is equivalent to the selected character.

According to an alternative embodiment, there is a processor for a transaction including a display including a user interface, an interface to a server configured to receive a plurality of human readable characters from a server, each of the human readable characters images encoded with a data stream associated with the human readable character image, the human readable characters forming a pattern presented on the user interface, and wherein the user interface allows for a user to select a human readable character from the plurality of human readable characters and the data stream associated with the selected human readable character is transmitted to the server. The processor further includes an input device comprising one of a mouse, a cursor, a keypad and a touch screen and wherein the user interface may present a payment window, the payment window configured to receive machine readable characters and transmit the machine readable characters along with the data stream associated with the selected human readable character to the server. The human readable characters may be representative of digits in a credit card number or representative of characters in a password. The pattern may be random or altered with each transaction.

There is further disclosed a method for secure transaction processing including receiving an encoded data stream representative of a plurality of human readable characters, selecting a human readable character from the plurality of human readable characters, and transmitting a portion of an encoded data stream representative of the selected human readable character. The method may further include positioning the human readable characters in a different order for each transaction and may further include inputting a machine readable character and transmitting the machine readable character along with the portion of the encoded data stream.

There is further disclosed a method of providing a secure transaction including encoding a set of human readable characters into a set of data codes, transmitting the data code to a user interface for selection by a user, receiving a selected portion of the data code; and decoding the selected portion of the data code. The method further includes receiving a machine readable character in addition to the selected portion of the data code. The data codes may be placed in a random order or placed in a different order for each transaction.

### BRIEF DESCRIPTION OF THE DRAWINGS

The following description is better understood when read in conjunction with the appended drawings, wherein

FIG. 1 is an example system configured in accordance with an embodiment of the disclosure;

FIG. 2 is an exemplary embodiment of the transaction session server shown in FIG. 1;

FIG. 3 is an example of a human recognizable character set;

FIG. 4 is an exemplary table illustrating the human recognizable character set 0-9 with an associated encoding scheme;

FIG. 5 is an example of a payment form utilizing a human recognizable character set for certain inputs;

FIGS. 6a and 6b illustrate flow charts illustrating exemplary methods of the disclosure;

FIG. 7 is an example of a human recognizable character set represented by a combination of individual images inside a grid;

FIG. 8 is another example illustrating a subset of the grid of FIG. 6;

FIG. 9 is an alternative embodiment of the system depicted in FIG. 1;

FIG. 10 is an alternative embodiment of the system depicted in FIG. 1;

FIG. 11 is an alternative embodiment of the system depicted in FIG. 1; and

FIG. 12 is a flow chart illustrating an embodiment of the method.

### DETAILED DESCRIPTION OF ILLUSTRATIVE EMBODIMENTS

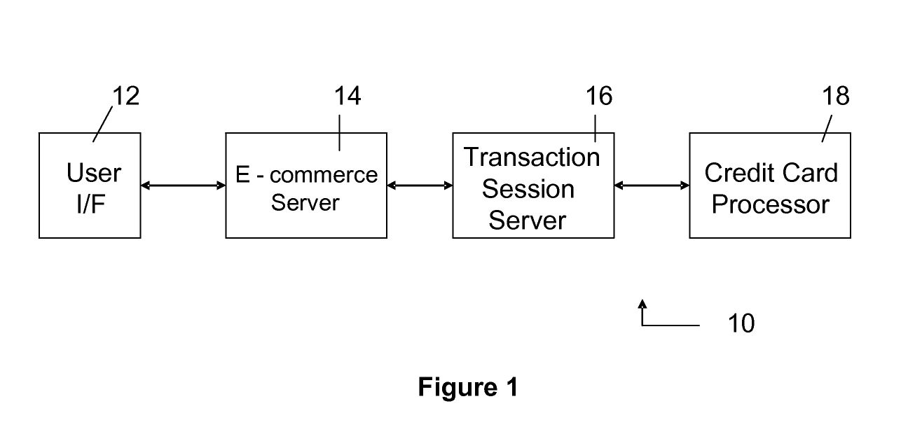

For the purposes of describing an exemplary embodiment of the invention, reference will be made to the figures set forth above. With reference to FIG. 1, there is shown a system 10 of an exemplary embodiment. The system 10 includes a user interface 12, an eCommerce server 14, a transaction session server 16 and a credit card processor 18. It will be understood by those in the art and by a description of several non-limiting alternative embodiments herein that the components that make up system 10 are not necessarily independent stand-alone components and may, in fact, be functions within a single component. The user interface 12 receives user inputs via keypad, touch screen, voice, or any other kind of known input mechanism and may include a display screen. The eCommerce server 14 is an exemplary server that facilitates on-line transactions and may, for example, be an electronic storefront. It should be understood that the eCommerce server is a non-limiting example only and there is no requirement that the invention be used in an eCommerce environment. The transaction session server 16 contains functionality to implement a visual challenge to be presented to a user through the user interface 12 as will be described in more detail herein. Finally, FIG. 1 shows a credit card processor 18 which may, for example, be a VISA® card processor owned or administered by or on behalf of a bank or other financial institution.

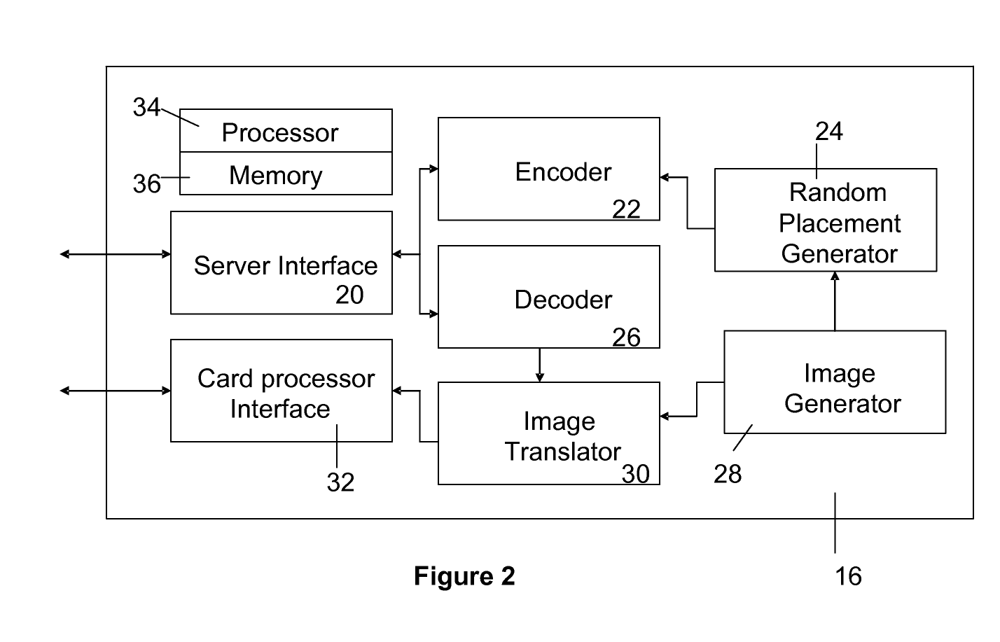

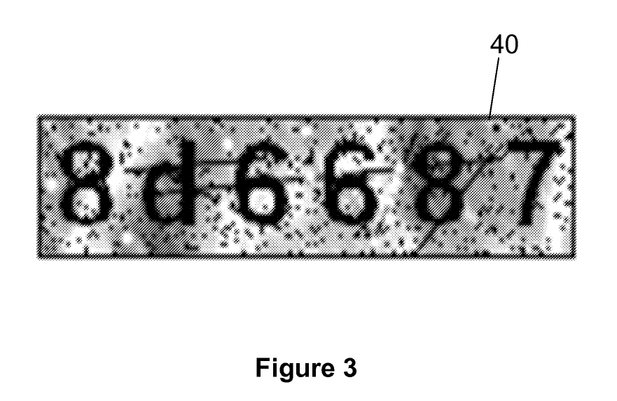

Turning now to FIG. 2, there is a more detailed description of the functionality of the transaction session server 16. The transaction session server 16 contains a server interface 20 which is in communication with the eCommerce server 14. The transaction session server 16 includes a processor 34 and memory 36 wherein the processor 34 controls the functions of the transaction session server 16 and the memory 36 provides local data and program storage. The image generator 28 generates human readable images representing each character upon command from the processor 34. The image generator 28 may, for example, generate CAPTCHA images as known by those skilled in the art. The image generator 28 and other functions may, for example, receive instructions from processor 34, including which images (numeric, alphanumeric or other characters). It will be understood that FIG. 2 represents an exemplary embodiment, but not to the exclusion of other embodiments contemplated herein, including having additional or only a subset of functions within the transaction session server 16 and that the directional arrows between functions may be altered to indicate other data flows falling between the functions within transaction session server 16. FIG. 3 illustrates an example of such human readable characters 40.

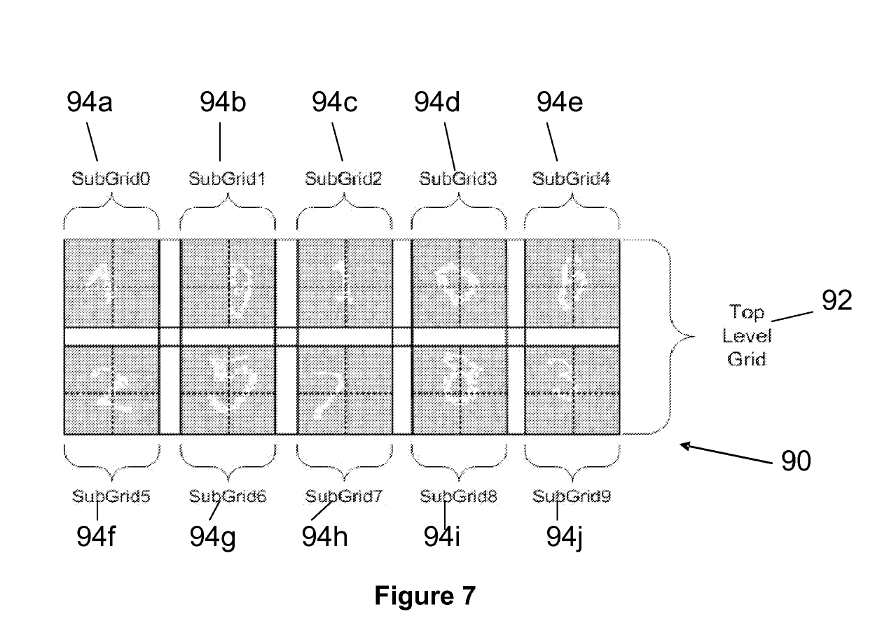

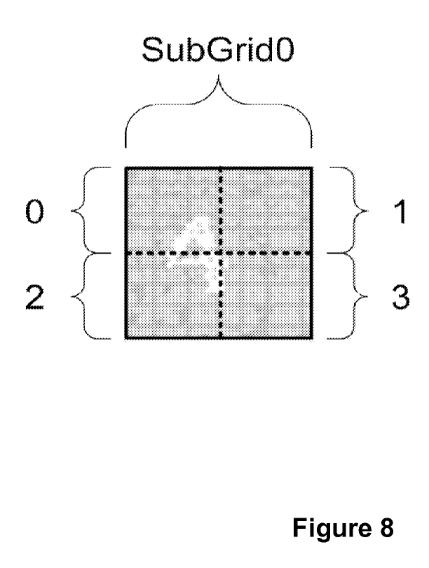

The image generator 28 then feeds the generated images to the encoder 22 which creates random codes for each character image then naming each image by the unique random code then passes the image files to the random placement generator 24 which then places the images in a random order. For example, if the image generator 28 generates human readable characters consisting of the numerals 0-9, the random placement generator 24 may place such human readable characters in the following order 9, 0, 1, 5, 3, 7, 2, 6, 8, 4. The random placement generator 24 may also place the images into a grid format 90 as shown in FIG. 7. The grid format 90 may include a top level grid 92 which determines the placement of the images on the user interface display and subgrids 94a-j which formulate the component parts of the images, shown in more detail in FIG. 8.

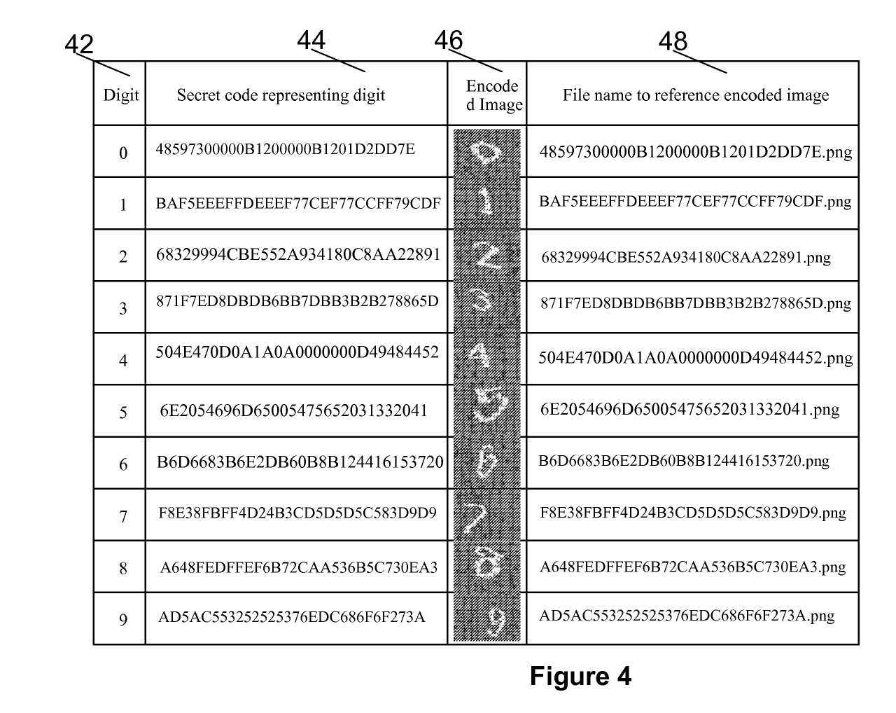

With reference to FIG. 4, the transaction session server 16 creates human readable character visual representations or images of all characters 46 which may be required for a user to produce transaction validation information, amongst other human readable characters presented to the user for each session. The transaction session server 16 generates individual human readable character images 46 representing the actual underlying alphanumeric digits 42, and then assigns each image a unique random code 44 known only to the transaction session server 16, such as, but not limited to a set of characters that could represent a uniquely random 128 bit number, along with an appropriate image file extension 48, such as but not limited to “.png.”

FIG. 4 displays numeric representations, which might provide a complete set of characters for inputting a credit card pin number, but it will be understood by those skilled in the art that the human readable characters to be generated may also include alphabet characters or other unique characters such as #, %, $ or other such characters or symbology which could be used to generate transaction validation information.

The transaction session server 16 then generates a page view, which presents the individual human readable character images, which for this example could be the images shown in FIG. 4, but the random placement generator 24 ensures that the images are essentially randomly distributed within a grid or framework, such as but not limited to the example provided in FIG. 7. While each human readable character has been randomly populated within this framework, the human readable character position is known by the transaction session server 16, so that each human readable character, for example “A648FEDFFEF6B72CAA536B5C730EA3.png” will be placed in a known position in the grid such that each human readable character image may be selectable using whatever input device or system is available to the user. It should be noted that it is not necessary for any part or function of the transaction session server 16 to know, or retain memory of, the position of the random code and image combination within the grid. The name part of the name/file type combination of the selected image itself, such as “A648FEDFFEF6B72CAA536B5C730EA3”, serves as the key to pass back to the Decoder function that would match up the random code to the real ‘secret’ server-side character counterpart represented in FIG. 4.

Each transaction session uses a completely new set of human readable characters, and each human readable character is provided a new random code, and each of these is then assigned a random location within the grid, and is only used for a single transaction session.

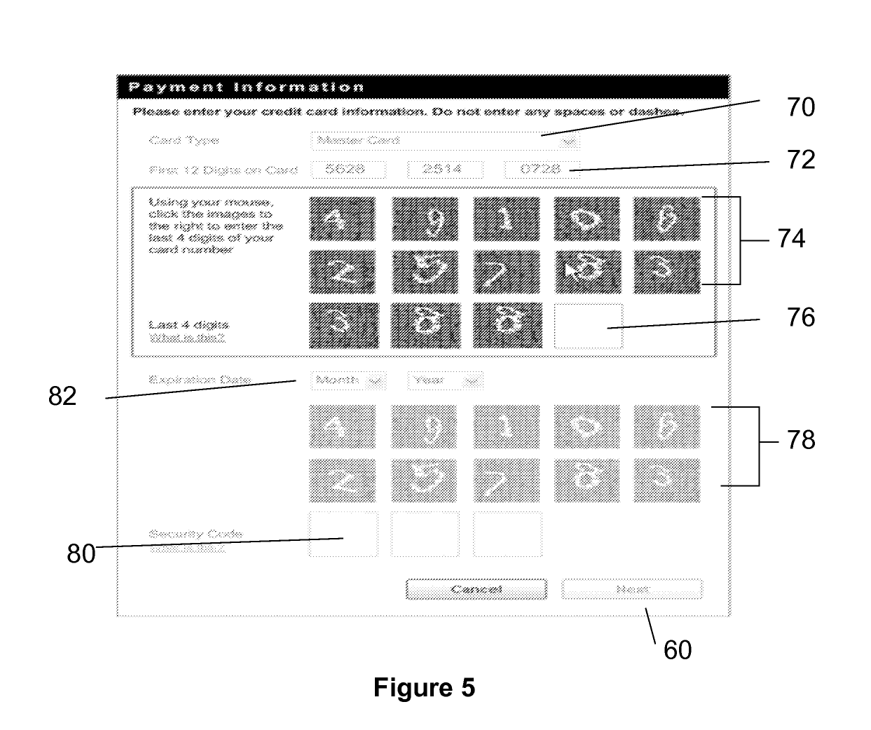

With reference to FIG. 5, there is shown a non-limiting example of a user interface 60. The exemplary user interface 60 has an area for the user to select a credit card type which may be in the form of a drop down list 70. A user would then enter the first twelve digits of their credit card information (5628 2514 0728 in this example) in a designated area 72 as they normally might do. Such character entry may be in machine readable code. It will be understood that while this example shows an area for the user to type the first twelve digits, such information could be populated from a database, such as would typically be performed using standard key entry methods, whether through keyboard, touch screen or keypad entry as examples. The user would then populate the final four digits from their credit card by selecting from the list of possible digits 74 by clicking on the human readable character images that visually represented the last four digits of the credit card number, in this case the last four digits being 3889. The 388 has already been populated in area 76 while the 9 shown being selected with the selection arrow. Continuing with this example, the user is able to enter the expiration date in fields 82 through drop down lists. The user is then provided the ability to enter the three digit security code which may be printed on the back of the credit card. The possible numbers are displayed in area 78 in human readable character form and the user may select the numbers in the manner described above wherein the selected numbers would then be visually shown on the user interface 60 in area 80.

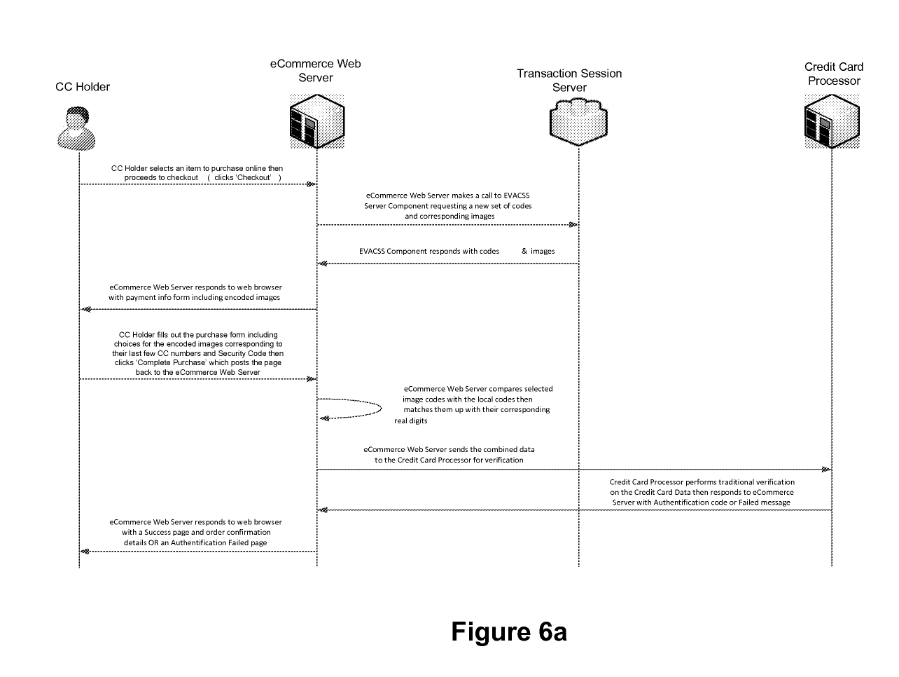

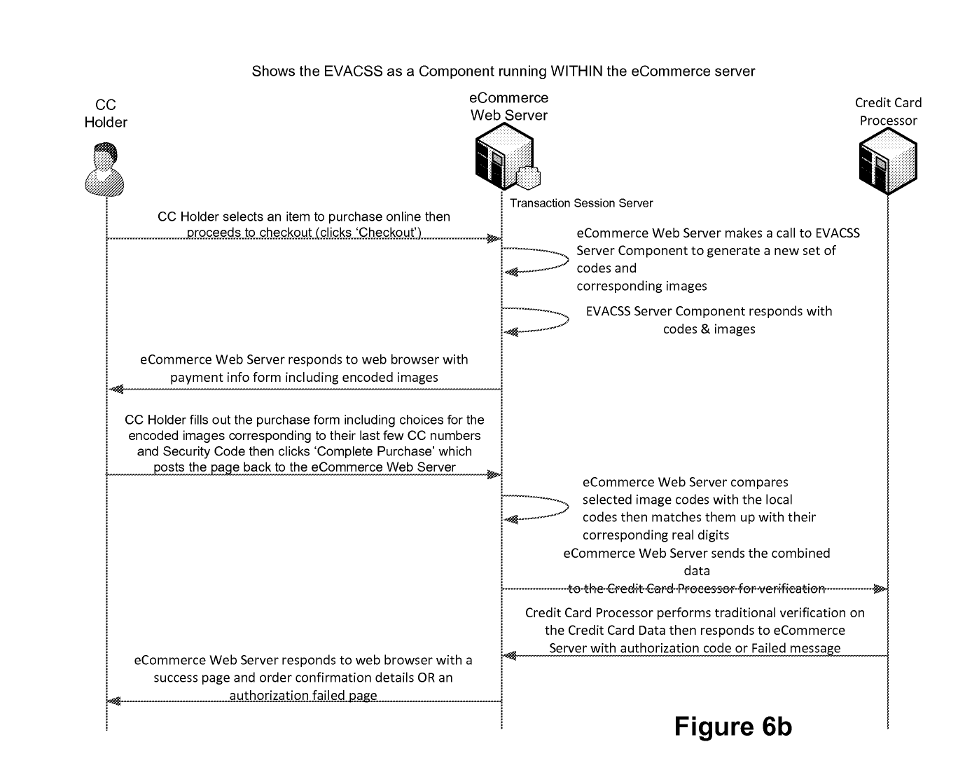

With reference to FIG. 6a, there is shown an exemplary method for the illustrative embodiment. There is shown a process flow diagram with a credit card holder, an eCommerce web server, a transaction session server and a credit card processor. It is noted that the transaction session server is also referred to herein and in some figures as an EVACSS (Enhanced Visual Authentication Challenge Secure Server). The eCommerce server, the transaction session server and the credit card processor server may use and maintain their own session details that would be used when interacting with each other. The transaction session would be a combination of information representing session information from each component that interacts with another component making up the overall session which interacts with the presentation method to the credit card holder. As can be seen, the credit card holder selects an item to purchase, triggering the eCommerce server to request a set of secure human recognizable character codes and images in a random order and then present images corresponding to those codes to the credit card holder to complete the input. The eCommerce server receives the input, substitutes the actual digits for the for the random codes corresponding to the human recognizable character codes received as chosen by the credit card holder, and then transmits the entire credit card information required to complete the transaction to the credit card processor for verification and approval authorization. The authorization is then provided back to the credit card holder indicating that the transaction has successfully been completed.

Essentially the method allows the user to interpret the images within the grid, and then use a non-deterministic entry method to identify the remaining transaction validation information digits or characters without using an input method which could generate machine readable characters or other such information which could compromise the security of the transaction session.

When the eCommerce server 14 receives the submitted “transaction validation information presentation page” it converts the selected choices back to their alphanumeric counterpart, which then allows the transaction session server 16 to securely fill in the missing digits for the balance of the credit card number, the credit card security digits and or possibly the credit card pin, and then submits the combined information to a credit card processor 18 for authorization of the payment.

The user interface 12 is never aware of the underlying real character value represented to the user via the human readable character images, nor does the user's input allow a CLS or other such system to generate machine readable code or other such information, yielding a highly secure transaction session.

An alternative process flow embodiment is illustrated in FIG. 6b. In that figure, it will be noted that the transaction session server and the eCommerce server are actually one server. The operation is similar to that described above, except that the communications between the transaction session server and the eCommerce server are shown as internal communications within a single server. This example illustrates that the transaction session server may be integrated into other application servers, including but not limited to e-Commerce, banking, stock trading, corporate networks, and any other system which requires a user to sign-in for identity confirmation.

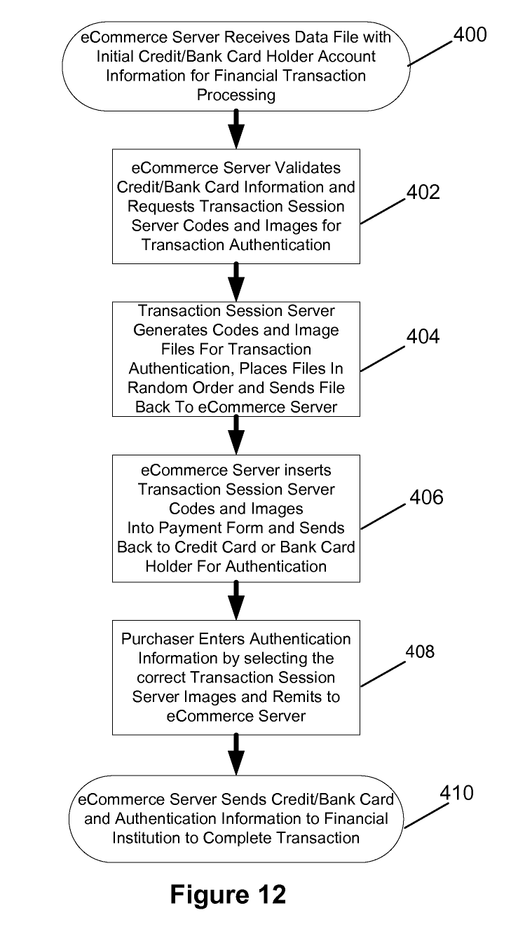

FIG. 12 illustrates a method of implementing a secure transaction server. At step 400, the eCommerce server receives a request for a transaction. At step 402, the eCommerce server requests transaction session server codes and images. At step 404, the transaction session server generates codes and image files and sends them back to the transaction session server. At step 406, the codes and image files are set into a payment form and sent back to the credit card owner for completion and authentication. At step 408, the credit card owner enters the authentication information and remits to the eCommerce server. Finally, at step 410, the eCommerce server communicates the complete credit card information to a credit card processor for completing the transaction.

In the context of web browsers when a web page connects to a web site server, which could form the basis of or possibly be associated with a transaction session server 16 there are several methods which could be used, but may not be limited in such use, to associate a particular transaction session to a remote process. For example, methods such as, cookie with web session ID, IP Address, URL with embedded query string, hidden form fields and other such unique identifiers. Any of the above methods could be used for association of browser session to server session but a combination could also be used. An example of two methods being used is an online banking site that uses cookies and hidden form fields to streamline the overall transaction session, leaving open or empty fields where a user would populate transaction validation information. When a returning user opens the browser to the banking site and has previously chosen for the site to remember their credit card number, the cookie is used to pass to the browser a code representing a user. When the server receives the code it looks up the card number associated with that user and sends back enough of the digits that the user can visually determine that the correct credit card number is entered by the transaction session server 16 before the user manually enters their credit card PIN or other such transaction validation information. A method to make this banking session more secure would be to have the PIN or other such transaction validation information entered via the transaction session server process.

Another feature of the method and system may be the uniqueness of the images. The random background pixilation within human readable character images, which may include, but are not limited to, shape, color, position, font style and any skewing of the image representing each digit must be reproduced for every session. Although today this solution will easily defeat current character logging systems, it is foreseeable that future versions of such systems may be adapted to include image processing algorithms. Using a random grid position within the presentation page, plus dynamically changing image attributes, make it virtually impossible for a hybrid character logging system with image processing capability to resolve images, considering the foreseeable processing capabilities that may be available. Due to the fact that codes are random for each session, even if a hybrid character logging system was able to discern a digit from a current session and therefore reveal its associated underlying code, it would be meaningless unless all codes for the entire session were also resolved. This is shown in FIG. 7, wherein a top-level grid 92 illustrates the random placement of the digits represented by the human readable codes and each of the subgrids 94a-94j illustrate the effects of shading and position placement may have. In the above example each grid/image within a subgrid item 94a-94j would have a unique image code associated with it, with each one making up part of the top level parent image. When the user selects any of the sub images in the grid regardless of the subgrid granularity the unique code contained in that section, when sent back to the server would associate with the parent element to resolve to the underlying server side digit.

According to another embodiment, the human readable character image type may be changed. For example, changing the human readable character image type to other browser supported formats such as .gif, .jpg, or .png randomly may also improve the ability of the system to confuse character logging systems.

Additionally, the image itself may be made up of any type of browser supported visual element or each transaction session server human readable character image may be represented visually by a combination of individual images inside a grid within a grid. As future display and computer processing technology advances become available, the number of individual grid/image elements may be increased over time, ensuring that the security of the process was maintained in the face of increasingly powerful and sophisticated character logging systems. This method would further combat possible future image processing character logging systems.

Placing the encoded images in a random position each time the grid is produced ensures that a security workaround based on the position of images could be managed, if not obviated.

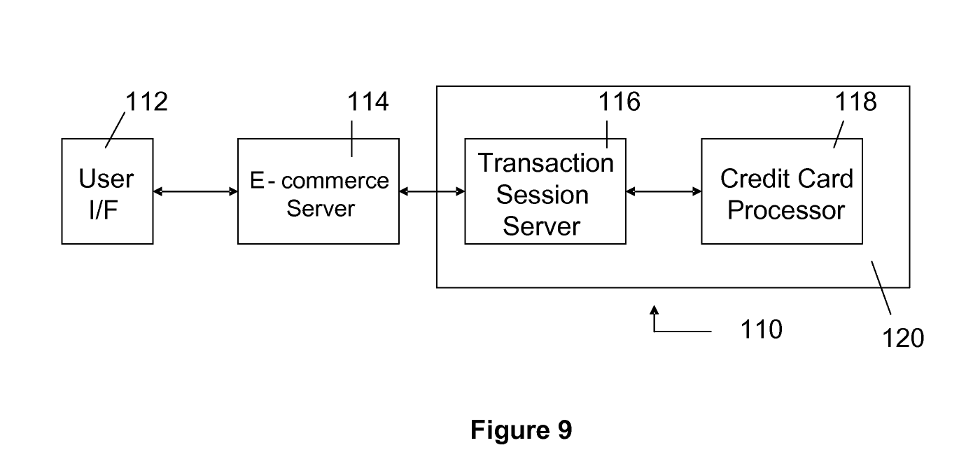

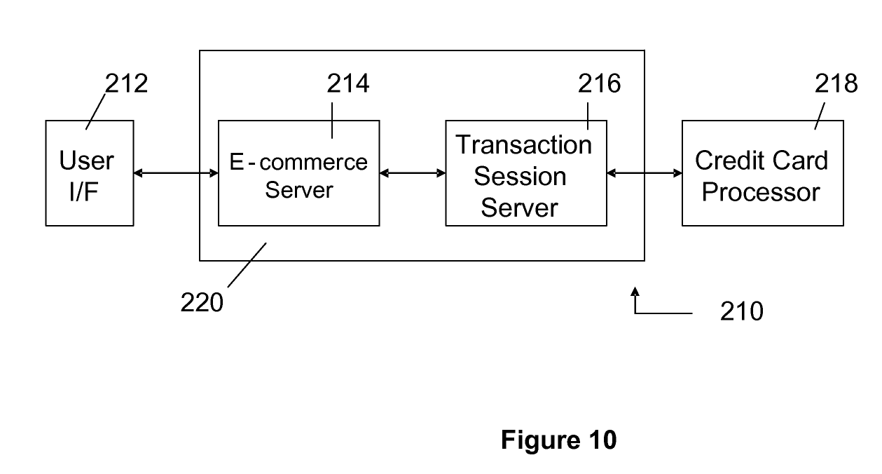

Alternative embodiments to the above description are found in FIGS. 9, 10, and 11. In FIG. 9, the transaction session server 116 and the credit card server 118 are part of a single server system 120, which then communicates with the eCommerce server 114 and the user interface 112 as illustrated. In FIG. 10, the eCommerce server 214 and the transaction session server 216 are part of a single server system 220 (similar to the configuration in the example of FIG. 6b above). The single server system 220 communicates with the user interface 212 and the credit card processor 218 as illustrated. Those skilled in the art will recognize that the functionality of each of these servers may be grouped in a manner that is consistent with the physical and logical architecture of a transaction system in any manner and is not limited by the exemplary examples of FIGS. 1, 9, and 10.

Additionally, other embodiments are included. For example, images representing characters can be generated in any language or character set. There may be options to adjust the size of the images to allow visually impaired persons to use the feature. There may be audio feedback available to assist hearing impaired persons to use the feature. The transaction system may use an audio file stored on the server that the user could then use to make an interactive choice to receive audible feedback on individual images. The audio file could be named using a similarly random code as is used for the corresponding human readable character images. There may be an option to re-generate one or more of the images if a person is visually impaired or is otherwise having difficulty discerning one or more of the human readable character images. These variations are exemplary only and non-limiting as to other variations.

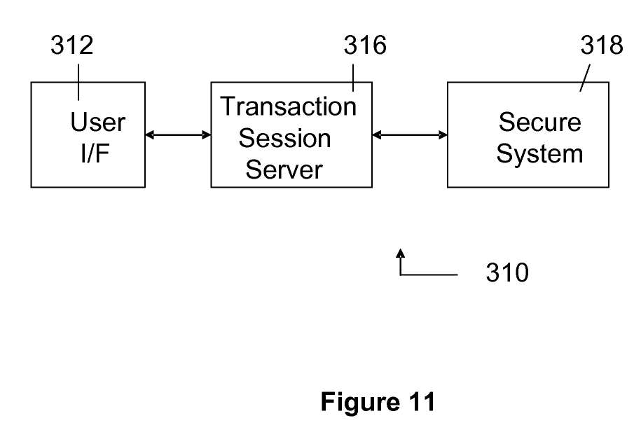

In addition to the eCommerce embodiment, the system and method may be used for other applications. With reference to FIG. 11, there is shown a system 310 which includes a user interface 312, a transaction session server 316 and a secure system 318. The secure system 318 may be, for example, a corporate computer network. The transaction session server 316 will operate in a manner similar to that described above in ensuring that character logging systems will not be able to breach the secure network. Other uses include, but are not limited to, consumer security when entering credit card data for an internet-based purchase, online banking login security, computer terminal login password entry, social security number secure entry on tax forms or other applications, keypad entry for building security or other such systems where character logging systems could be physically or electronically employed to capture user input.

While the encoded visual authentication challenge for secure systems has been described in connection with the various embodiments of the various figures, it is to be understood that other similar embodiments can be used or modifications and additions can be made to the described embodiment for performing the same types of functionality without deviating therefrom. The encoded visual challenge may be presented to a user via a terminal or other type of user interface, including mobile devices, PDAs, smartphones, netbook and notebook computers, and keypads. Therefore, the system and method should not be limited to any single embodiment, but rather should be construed in breadth and scope in accordance with the appended claims.

What is claimed is:

1. A secure transaction system comprising:
an image generator configured to generate human readable characters;
an encoding system configured to encode the human readable characters in a data stream;
wherein the transaction system is configured to transmit the data stream to a user interface and to receive a selected data stream from the user interface.

2. The secure transaction system of claim 1 wherein the transaction system is configured to further receive machine readable codes in addition to the selected data stream.

3. The secure transaction system of claim 1 further comprising a card processor interface configured to communicate with a credit card processor wherein the secure transaction server decodes the selected data stream to a machine readable character and transmits the machine readable character to the credit card processor.

4. The secure transaction system of claim 3 wherein the selected data stream represents a character selected at the user interface and the machine readable character is equivalent to the selected character.

5. The secure transaction system of claim 1 wherein the human readable characters are representative of one of a portion of a credit card number, a password, and login credentials for a secure terminal.

6. The secure transaction system of claim 1 further comprising a random placement generator coupled to the image generator and wherein the encoding system is configured to encode the human readable characters in the data stream in an order determined by the placement generator.

7. The secure transaction system of claim 6 wherein the order differs between transactions.

8. A processor for a transaction comprising;
a display including a user interface;
an interface to a server configured to receive a plurality of human readable characters from a server, each of the human readable characters encoded with a data stream associated with a human readable character image, the human readable characters forming a pattern presented on the user interface;
wherein the user interface allows for a user to select a human readable character from the plurality of human readable characters and the data stream associated with the selected human readable character is transmitted to the server.

9. The processor of claim 8 wherein the processor has an input device comprising one of a mouse, a cursor, a keypad and a touch screen.

10. The processor of claim 8 wherein the user interface presents a payment view, the payment view configured to receive machine readable characters and transmit the machine readable characters along with the data stream associated with the selected human readable character to the server.

11. The processor of claim 8 wherein the human readable characters are representative of one of digits in a credit card number, characters in a password and login credentials to a secure system.

12. The processor of claim 8 wherein the pattern is random.

13. The processor of claim 8 wherein the pattern is altered with each transaction.

14. A method for secure transaction processing comprising:
receiving an encoded data stream representative of a plurality of human readable characters;
selecting a human readable character from the plurality of human readable characters;
transmitting a portion of the encoded data stream representative of the selected human readable character.

15. The method of claim 14 further comprising positioning the human readable characters in a different order for each transaction.

16. The method of claim 14 further comprising inputting a machine readable character and transmitting the machine readable character along with the portion of the encoded data stream.

17. The method of claim 14 wherein the human readable characters are representative of one of a portion of a credit card number and a password.

18. A method of providing a secure transaction comprising:
encoding a set of human readable characters into a set of data codes;
transmitting a data code to a user interface for selection by a user;
receiving a selected portion of the data code; and
decoding the selected portion of the data code.

19. The method of claim 18 further comprising receiving a machine readable character in addition to the selected portion of the data code.

20. The method of claim 18 further comprising placing the set of data codes in a random order.

21. The method of claim 18 further comprising placing the set of data codes in a different order for each transaction.

22. The method of claim 18 wherein the human readable characters are representative of one of a portion of a credit card number and a password.
